(19) United States
(12) Patent Application Publication
(10) Pub. No.: US 2011/0191597 A1
(43) Pub. Date: Aug. 4, 2011

(54) METHOD AND SYSTEM FOR SECURING SOFTWARE

(75) Inventor: Eric Grall, Quimper (FR)

(73) Assignee: THALES, NEUILLY SUR SEINE (FR)

(21) Appl. No.: 13/056,335

(22) PCT Filed: Jul. 29, 2009
(86) PCT No.: PCT/EP2009/059825

§ 371 Date: Apr. 20, 2011

(30) Foreign Application Priority Data
Jul. 29, 2008 (FR) 0804321

(51) Int. Cl. G06F 9/46; H04L 9/32

(52) U.S. Cl. 713/189; 718/100

(57) ABSTRACT

In a method and system for securing a software package that can be broken down into a number of “event-action” type independent tasks, the tasks managing a set of “scripts”, the method includes using a script and message encapsulation module and a transmission of encapsulated scripts to a trust resource suitable for executing them.

The invention relates to a method and a system architecture for securing a software package, for example an executable. The term “securing or secure” designates in this description the fact of making a software package inaccessible to any person who is not authorized to know its content.

It is situated in the hardware domain and in the software domain for “securing” the intellectual property of a software package, that is to say, making inaccessible the information contained in a software package or even certain portions of an executable that are in a binary format or an interpreted code. Hereinafter in the description, the word “script” is used, either to designate a text file comprising a series of commands that are used to automatically execute and sequence most of the functions usually accessible, or a binary file corresponding to executable code in a given environment. The scripts therefore offer the possibility of sequencing, without intervention from the user, notably events, etc. They will also cover encrypted scripts corresponding to a script to which an encryption algorithm will have been applied in order for only the authorized resources or people to be able to access the information contained in the software.

In the conventional development of a software package, the problem of the intellectual property of the source code often arises. This problem occurs, for example, in the domain of trust platforms on which one or more executables can be implemented with a security level that makes it possible to counter theft or avoid the reverse engineering of the software operating on the machine. To the knowledge of the Applicant, the problem of the security of an executable is generally handled by implementing cryptographic mechanisms that can be used to encrypt the executable on a storage medium that is accessible in read-only mode, known by the abbreviation ROM (read-only memory) or else a rewritable mass memory or FLASH memory, and to decrypt it either on startup in a working memory (RAM, standing for random access memory), or on the fly in the case of an interpreted code, for example the JAVA language and its “By-code”, or else the Python language, languages that are known to those skilled in the art. This amounts to having on one and the same machine, a microprocessor that can be used to process the binary file of the executable and to decrypt it by using an integrated cryptographic resource. For the JAVA language, the code is decrypted on the fly and executed by the JVM (Java Virtual Machine) interpreter of the host machine. This technique therefore first encrypts all the executable code and then the code is decrypted before being executed by a microprocessor or else a part of the encrypted byte code is interpreted by a specific interpreter.

The patent application US2007006169A1 discloses the use of cryptological resources in order to confer confidentiality, integrity or authentication properties via the encryption of storage memories. This type of resource may be associated with the TPM (Trusted Platform Module) standard incorporated in most civil equipment.

The U.S. Pat. No. 7,210,009 relates to a system comprising a processor configured to ensure a security execution mode for any software.

Generally, the mechanisms described in the prior art exhibit the following disadvantages:
it is one and the same calculation resource (microprocessor) which allows the executable to operate and which has in the end all the source code;
the trust in a system is completely centralized at the level of the decryption resource which has the sensitive elements (keys, certificates, etc.).
the known mechanisms do not offer any flexibility in their capacity to separate the so-called “sensitive” code portions and the other so-called “public” code portions.

The subject of the present invention relies on a novel approach that makes it possible to ensure the protection of the authors' rights associated with the software, while doing away with the drawbacks that exist in the prior art. To this end, the subject of the present invention implements a script or message encapsulation and a transmission of the encapsulated scripts to a trust resource suitable for executing them.

The scripts may or may not be encrypted, in which case the trust resource decrypts the latter before execution.

The invention applies notably to software that can be implemented in the form of state machines.

In this context, the word “encapsulation” denotes the fact of using another protocol in order to transport a portion or all of the scripts in a medium suited to this transport protocol. In this invention, the scripts will be formatted in messages which will in turn be encapsulated in communication protocols of IP type, etc. The subject of the invention relates to a method for securing a software package that can be broken down into a number of “Event-Action” type independent tasks, said tasks managing a set of encrypted or unencrypted “scripts”, characterized in that it comprises at least the following steps:
breaking down the software package to be secured into a number of independent tasks Ti,
upon the occurrence of a start event Evₛₜₐᵣₜ, selecting at least one of the tasks Ti consisting of a set of scripts,
said selected task or tasks Ti, the target of the event Evₛₜₐᵣₜ, will select one or more of their scripts according to their internal operating state corresponding to the progress of a task with respect to the program or software package, and will format at least one message with the appropriate scripts,
said task or tasks send said message or messages via a communication module encapsulating said message or messages according to the dedicated transmission medium,
transmitting said encapsulated message or messages to at least one dedicated resource via a communication means, said dedicated resource or resources being determined by a parameter included in said encapsulated message or messages,
said dedicated resource or resources then execute the encapsulated message or messages,
the execution of a script generates another event E'v including the identifiers necessary for the rest of the procedure, and the result of the execution,
the event E'v will then be sent to the various tasks Ti connected to the communication means that will or will not be stimulated for another action, and so on until an end-of-process event Ev_{end} is received.

At least one of the tasks comprises, for example, one or more encrypted scripts and said dedicated resource is a cryptographic resource CE which decrypts the encapsulated message before executing it based on an identifying parameter contained in the script and associated with a decryption key.

The communication means may be a communication bus or a messaging system.

The software package is, for example, an executable software package or in the form of interpretable code, or else a binary software package or in the form of interpretable code.

According to one embodiment, the method according to the invention comprises a single resource CE and a virtualization software module suitable for partitioning different tasks Ti, each task being executed on an operating system OS which communicates with the virtualization module.

The invention also relates to a system for securing or protecting a software package that can be broken down into a number of “Event-Action” type independent tasks, said tasks managing a set of “scripts”, characterized in that if comprises at least the following elements:
A module for encapsulating a selected module in a task Ti which is in turn selected according to the state of the software and an external event, and for converting it into the form of a message encapsulating the selected module.
A module for transmitting the message encapsulating the selected module via a communication means to one or more resources for executing said message and said selected module.

The system comprises, for example, a number of cryptographic resources comprising a module for decrypting said selected encrypted module, associated with an encryption key and a module for executing said module after decryption.

The communication means is, for example, a communication bus or a messaging system.

The encryption module may comprise at least one of the following encryption algorithms: a symmetrical Aes (Advanced Encryption Standard) algorithm, an asymmetrical RSA (Rivest Shamir Adleman) type algorithm, cryptographic algorithms and an encryption key Ks.

Other features and advantages of the device according to the invention will become more apparent from reading the following description of an exemplary embodiment given as an illustrative and by no means limiting example, with appended figures which represent:

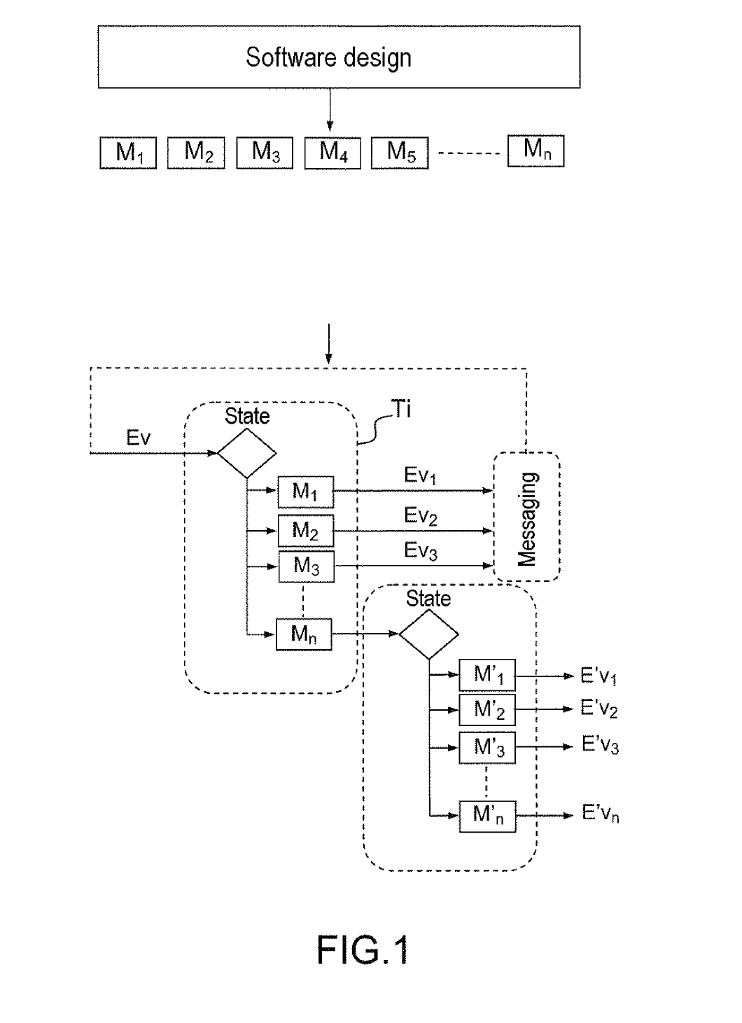

FIG. 1, an exemplary subdivision in the form of an event tree of a software package to be secured consisting of a number of independent binary or interpreted modules or services,

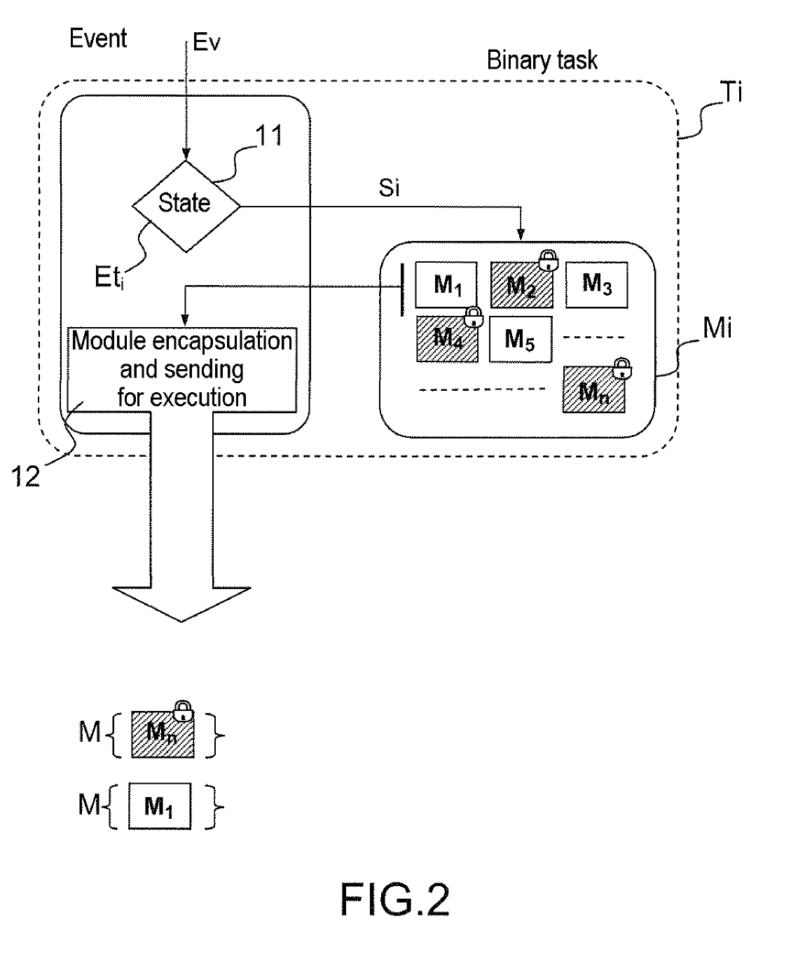

FIG. 2, a definition for a binary task managing the selection of a number of binary or interpreted modules, comprising unencrypted scripts and encrypted scripts,

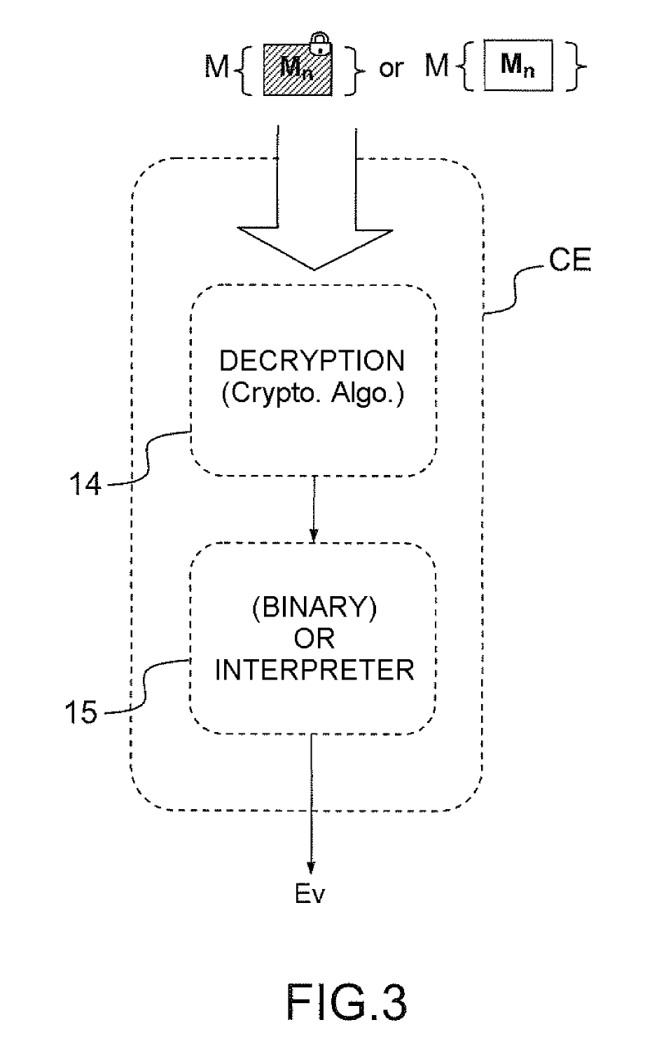

FIG. 3, a definition for the software or hardware resource managing the execution of modules,

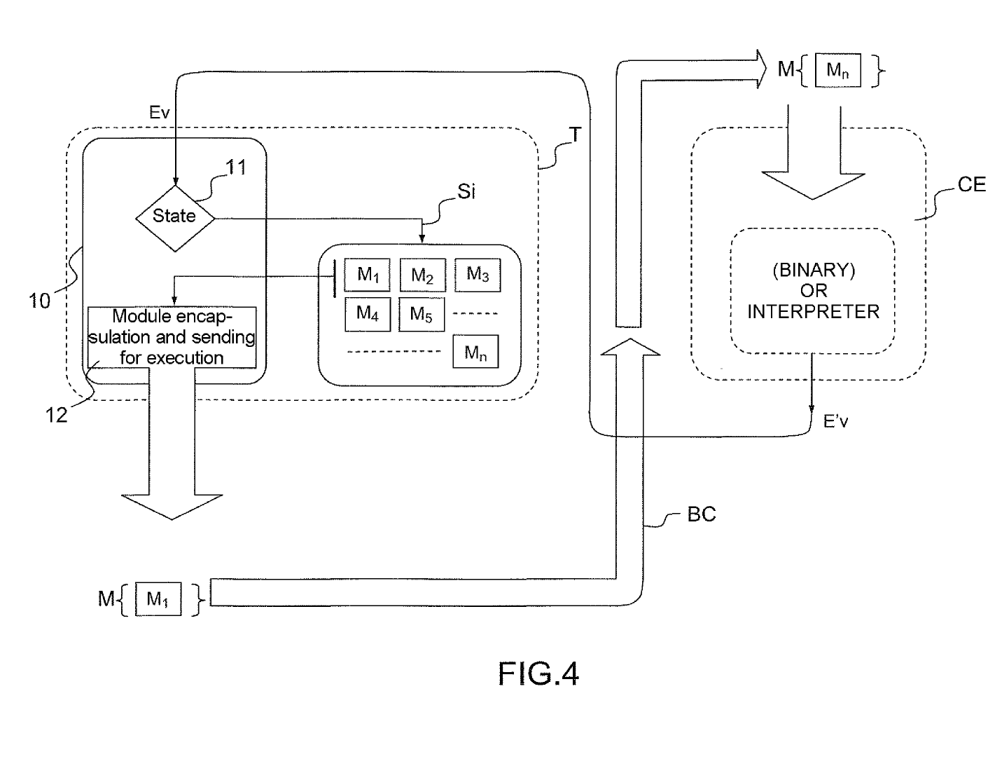

FIG. 4, an exemplary connection diagram between the software to be secured and an external resource with which to execute it,

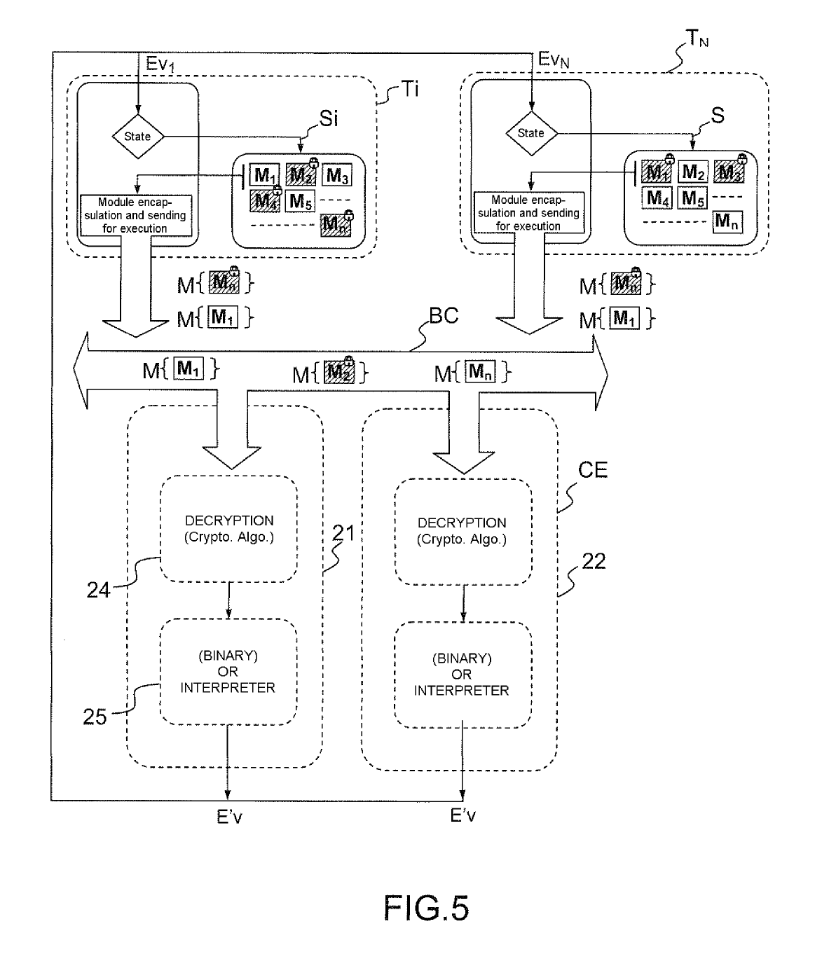

FIG. 5, an example of use of a number of tasks and resources,

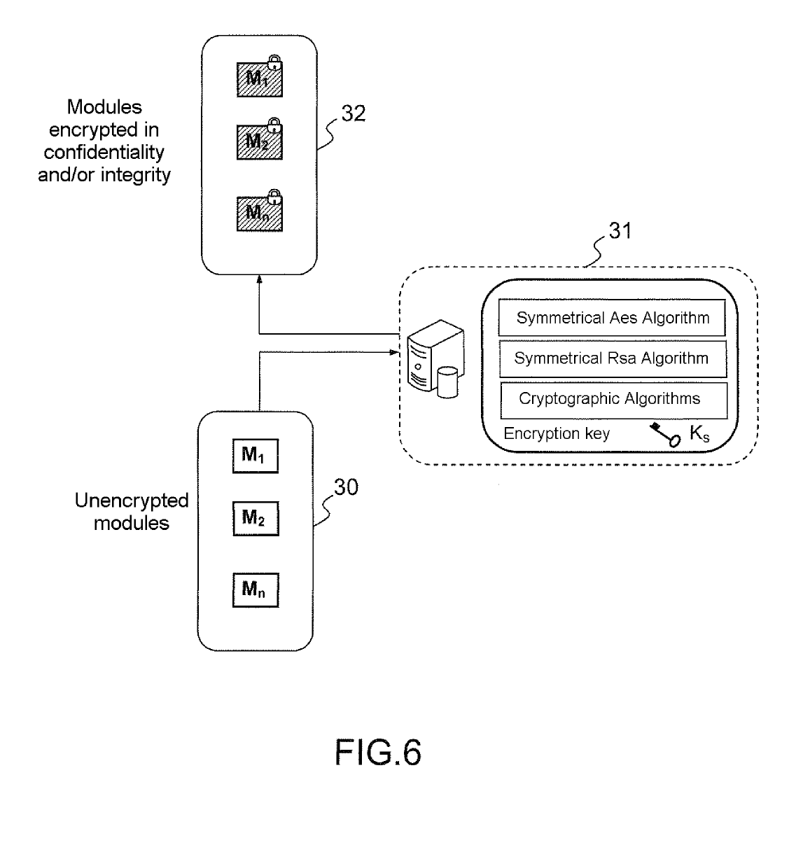

FIG. 6, an example of external resources encrypting the sensitive modules,

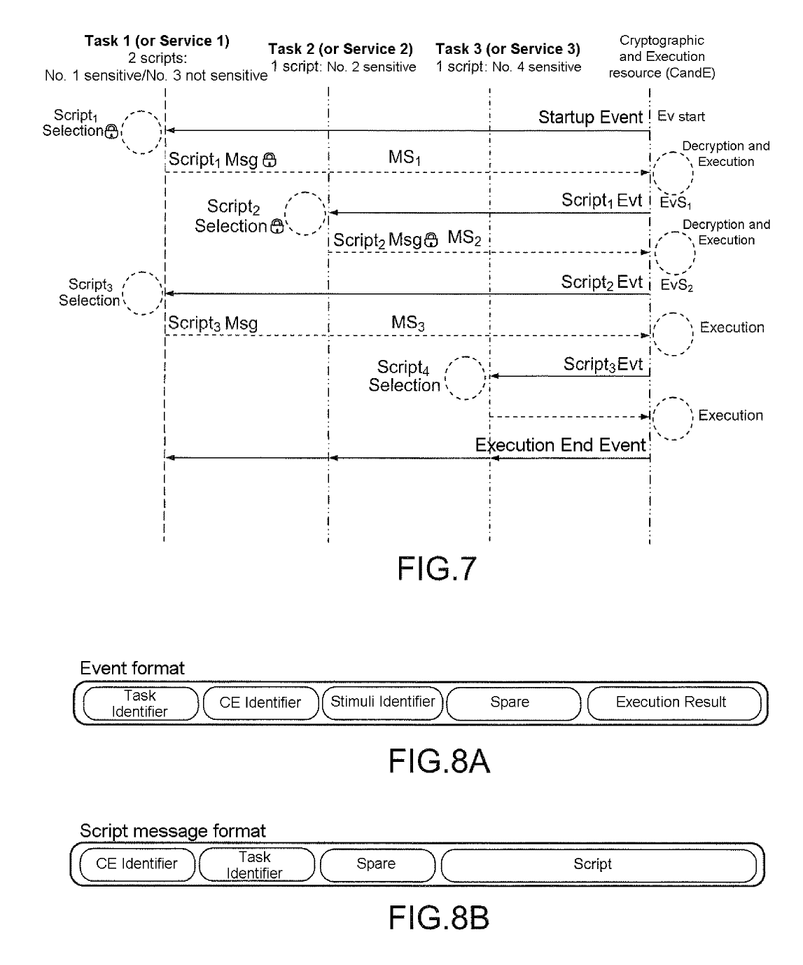

FIG. 7, a block diagram of various events and the various tasks executed,

FIGS. 8A and 8B, an exemplary format, respectively for an event and for a script message,

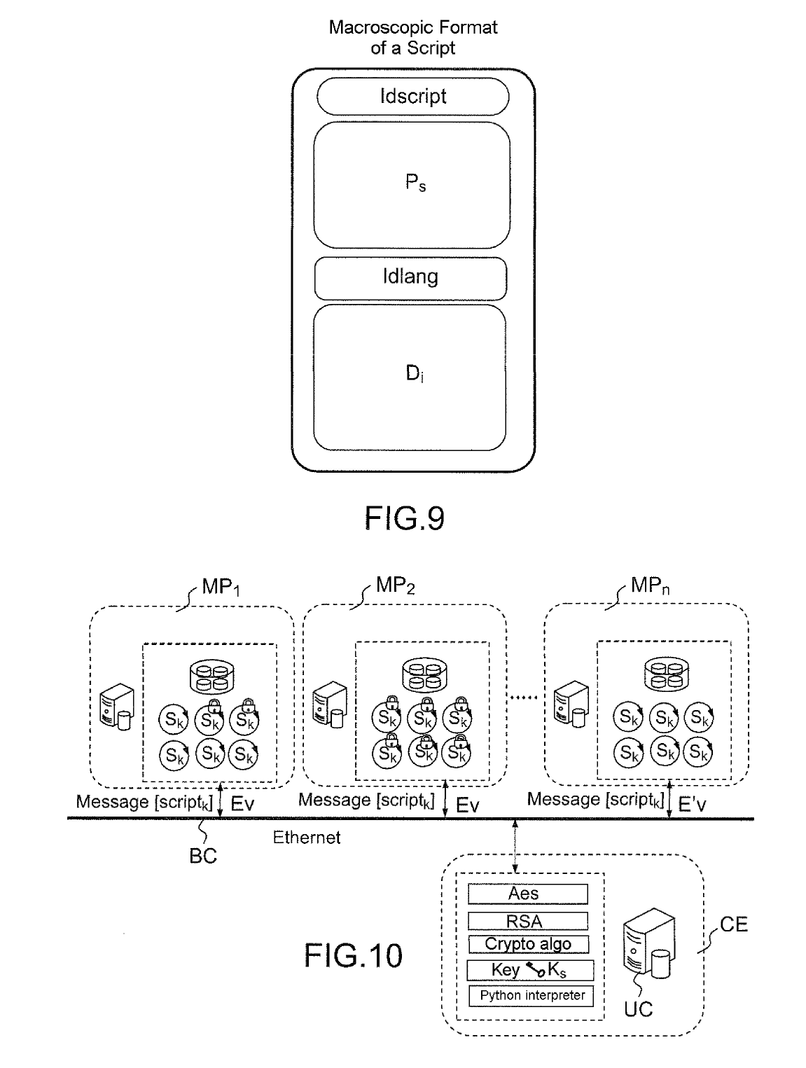

FIG. 9, an exemplary macroscopic format for a script,

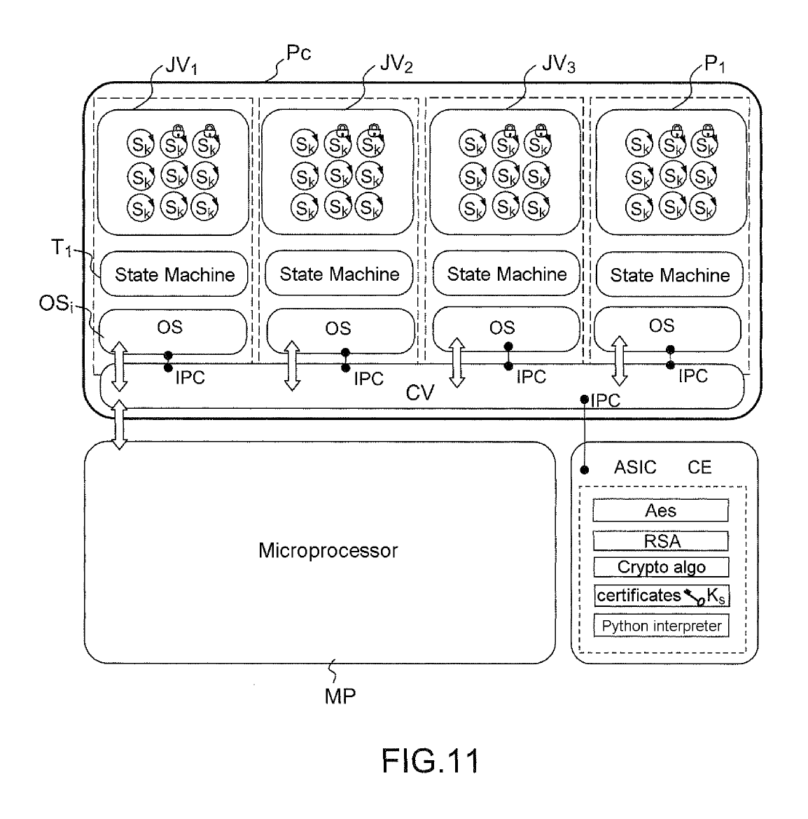

FIGS. 10 and 11, two exemplary implementations of the method according to the invention.

In order to give a better understanding of the subject of the present invention, the following description will be given in relation to a software package, for example an executable, that can be described as a number of tasks Ti operating on the “event-action” principle, a principle known to those skilled in the art. The software is therefore modeled on the principle of tasks or functional services triggered via external events. These tasks will make it possible, on the same principle as a state machine, to react to an external event by selecting the appropriate script (appropriate with respect to its internal state). However, instead of executing the script, the task (or service) will encapsulate the encrypted or unencrypted script in a message intended for a cryptographic resource.

Each of these tasks or services is defined by one or more scripts generating a particular event.

FIG. 1 shows a software package that can be broken down into a number of independent modules Mi or binary services. The software package may be represented in the form of an event tree.

The operation of such a software package is illustrated in FIG. 7. The startup event Evₛₜₐᵣₜ is sent by a cryptographic and execution resource CE. This event selects a first task T1 consisting of a whole script. In the example, the script is an encrypted script, the padlock symbol representing the encryption. This script S₁ is transmitted in the form of a script message MS₁, to the cryptographic and execution resource CE. The task that is the target of the start event will select one or more of its scripts depending on its internal operating state corresponding to progress with respect to the program and format another message with the appropriate scripts, then will send this message via a communication module whose function is notably to encapsulate said message according to the transmission medium. The resource CE decrypts and executes the script S₁. The execution of the script S₁ generates a script event EvS₁ which will select another software script, for example, encrypted script S₂. A message MS₂ resulting from this encrypted script S₂ will be sent to the resource CE which will firstly decrypt it and execute it once decrypted. Following this execution, a script event EvS₂ will be transmitted to the software which will select a script S₃ which, in this example, is unencrypted, and so on until the software receives an end-of-execution event Ev_{end}.

The format of an event may be that represented in FIG. 8A. The format of an event comprises, in one case, an identifier of the task to be executed, an identifier of the cryptographic resource CE on which the chosen script will be executed according to a given event and the state of the system characterized by all the states of the script selection tasks. This state corresponds to the event/stimulus view at an instant T in the software execution progress, a stimuli identifier, a spare area and an area comprising the result of the execution.

The format of a script message may be that of FIG. 8B, namely, an identifier of the cryptographic resource on which the script will be executed, an identifier of the task to be executed, a spare area and a portion containing the script-specific data. FIG. 9 proposes a macroscopic format for a script, comprising a script identifier Idscript, a security policy Ps comprising the state of security of the script, namely, whether or not it should be secured, the identifier of the cryptographic resource that will be used, data specific to the encryption algorithm used, an identifier corresponding to the script language Id Lang, binary or interpreted data specific to the script, Di.

A task has the capacity of a state machine reacting to external events by selecting one or more encrypted or unencrypted scripts via an external cryptographic resource CE.

These scripts, which may be binary code (example: Java or compiled C++), interpreted code (example: java, php or python), or script (example: tcl, javascript), will then be encapsulated in a message M{Mi} to one of the cryptographic resources CE of the complete system. In the case where the scripts have a certain sensitivity (or confidentiality), these scripts will be encrypted via an external cryptography resource (PC-type machine that has appropriate cryptographic elements) before being inserted into a task (or a service) as described in FIG. 6.

The scripts managed by the tasks Ti make it possible to generate an event Ev and a particular execution result.

The architecture of the system according to the invention relies notably on the use of a number of entities shrewdly combined together which will be described on their own or together in FIGS. 2 to 6. FIGS. 10 and 11 will illustrate two examples of use. The various software entities and cryptographic resources communicate, for example, via a communication means such as a communication bus.

FIG. 2 diagrammatically represents an exemplary definition of a binary task Ti managing the selection of a number of modules Mi or binary or interpreted services according to an external event Ev and its state of execution in terms of progress in the running of the program. This state is specific to each of the tasks but depends on the overall progress of the software.

The binary task Ti or 10 manages a set of modules Mi in binary or interpreted form, and selects Si one of these modules Mi according to an event Ev and its internal state Eti, 11. The task Ti corresponds to the “state management” portion of the event tree but, instead of directly executing the selected binary module Mi, the task Ti encapsulates in a message the module Mi by virtue of an encapsulation module 12 and the encapsulated message M{Mi} is then transmitted via the same module or a specific transmission module which is used to send it, for execution by an external resource CE. The modules Mi may or may not be encrypted, the representation of an encrypted module takes the form of a padlock in the figure. This resource CE (FIG. 3) comprising a decryption module 14 when the modules have been encrypted and a binary module 15 or an interpreter depending on the format of the encapsulated message received. The encapsulated message M{Mi} is executed in the external resource CE, and the execution generates an event Ev. A task represented in FIG. 2 notably has the following functions:
it manages a set of modules Mi in binary or interpreted form, encrypted or unencrypted, and selects one of these modules according to an external event and its internal state,
it corresponds to the “state management” portion of the event tree, but, instead of directly executing the binary module, it will encapsulate it in a message and send it for execution to an external resource,
it therefore has no view of the modules, other than their selection according to a set of internal and external parameters (Ev for event, State).

The system according to the invention may comprise one or more external resources CE, having symmetrical and asymmetrical cryptographic functionalities. For this, the cryptographic resources have, for example, a cryptography module 14 adapted for generating and managing keys, certificates, symmetrical and asymmetrical cryptographic algorithms (FIG. 3). Generally, an external resource also has a software code execution module, 15, or a computation unit, for example, in the case of the language, it may be a JVM (Java Virtual Machine) interpreter, in the case of a compiled language, it may be a boot loader, used to implement an executable on a target machine. This cryptographic resource may be implemented as hardware (for example: microprocessor with an internal cryptographic resource, FPGA, Field-Programmable Gate Array, or ASIC, Application-Specific Integrated Circuit) or as software on a dedicated microprocessor. The cryptographic algorithms managed by this resource will be of symmetrical type, such as the AES and 3DES algorithms, and of asymmetrical type such as the RSA and El Gamal algorithms. The keys or the certificates corresponding to the use of these algorithms will be managed by the cryptographic resources.

To sum up, the external resource CE notably has the following functions:
it decrypts the binary or interpreted module (encrypted via an external system) encapsulated in the message via a set of cryptographic algorithms;
it manages the execution of the module in binary form, or interpreted form, via its capacity as “boot loader” in the binary case and as interpreter 30 in the case of a “bytecode” or equivalent;
it executes and returns the result of the execution in the form of an event;
it has only a relative view of the program because it is fragmentary.

The executable then operates on the principle of a state machine in which each of the scripts generates an event intended for a particular task or for a number of tasks (or a service) and thus allows, via the running of a number of tasks (and associated scripts), the execution of the software program.

In the context of this solution, it is possible to encrypt the confidential scripts of a task (or of a service) via a cryptographic resource (external) as is described in FIG. 6. FIG. 4 diagrammatically represents an exemplary connection diagram between a software package consisting of a set of tasks managing binary modules Mi or interpreted modules and which transfers their execution to an external resource CE, CE being dedicated, via a communication bus or a messaging system transporting the binary modules and the events. The encapsulated messages M{Mi} pass along the communication bus BC to the dedicated resource CE. The encapsulated message M{Mi} is executed by the dedicated external resource CE. The executed message generates an event E′v which will act on the state module 11, Eti. The task or tasks Ti that are the targets of a process-triggering event will select one or more of its scripts depending on their internal state of operation specific to each of them corresponding to the progress with respect to the program or software and will each format a message with an appropriate script. A task will then transmit this message via a communication module encapsulating the message according to the transmission medium concerned.

The communication bus BC positioned between the tasks or services and the cryptographic resources makes it possible to transfer the events and the messages. These events will transport, for example, the triggering stimulus for one of the tasks and the result of the execution of a script, which takes the form of an event. The messages will transport the execution scripts. The execution scripts will be formatted in the form of messages which will be communicated (or transported) via a communication bus. The communication bus may be either a conventional software messaging system, or middleware known to those skilled in the art or even an equivalent system having at least equivalent functionalities.

FIG. 5 represents a variant implementation comprising a set of tasks Ti consisting of a number of binary and interpreted modules and two resources CE, 21, 22. Each of the tasks Ti is linked via a communication bus BC to dedicated resources 21, 22 which will receive the messages encapsulated by the tasks Ti and execute them, by decrypting them beforehand in the case where the encapsulated messages are encrypted.

The encapsulated messages may be encrypted messages or unencrypted messages. To process the encrypted and encapsulated messages, the cryptographic resource CE will then decrypt 24 the script according to the identifier of the task and will then execute it via its internal interpreter 25 (or a “boot loader” in the case of a compiled binary), thus generating a new event E'v. This event will then be transmitted to all the tasks connected to the cryptographic resource, which can react to this stimulus according to their state.

The implementation of a number of cryptographic resources makes it possible notably to “disperse” or “distribute” the execution of the code over a number of cryptographic resources in order to avoid, on the one hand, a centralized knowledge of the complete code by a single resource, and, on the other hand, to allow for the management of a failure mode in the case where one of the resources no longer operates (redundancy of the cryptographic resources).

FIG. 6 is an exemplary external resource suitable for encrypting the modules that are said to be sensitive in the security sense. The unencrypted modules 30 are transmitted to this encryption resource 31 which delivers modules that are encrypted, for example, in confidentiality and in integrity 32. The encryption resource 31 comprises, for example, the following elements: a symmetrical Aes (Advanced Encryption Standard) algorithm, an asymmetrical RSA (Rivest Shamir Adleman) type algorithm, cryptographic algorithms and an encryption key Ks.

The development and the encryption of the “sensitive” modules must be performed in a controlled area corresponding to the sensitivity level of this portion of the software. Once encrypted, these modules can be manipulated by any software deployment means known to those skilled in the art.

FIGS. 7, 8A, 8B and 9 explained above show, on the one hand, the block diagram of the steps implemented by the method according to the invention, and exemplary formats for the messages. The method according to the invention relies notably on the modeling of a software package or executable as a number of tasks or services that are mutually independent and that will be triggered by external events. The method used is based on the implementation of a number of phases:
breakdown of an executable into a number of “Event-Action” type independent tasks, managing a set of scripts having different sensitivity levels, including encrypted and/or unencrypted scripts,
connection of the defined tasks to one or more cryptographic resources via a communication system (software bus, messaging, etc.),
each of the modules will have a unique identification.
each of the actions of the program will then run as follows:
on a given event, one of the tasks (the destination task) will select one of the scripts according to its internal state as in the case of a state machine, and send it via a message to one of the “C&E” resources.

This choice will be defined in the script itself;
The cryptographic resource will then decide whether the script is secured. In the case where the script is unencrypted, the cryptographic resource will execute it directly via its internal computation unit (CPU), otherwise it will first of all decrypt the script via its cryptographic unit, and the key (and other cryptographic information of the security policy) associated with the identifier of the script;
The execution of the script will then generate another event, including the identifiers necessary for the continued running, and the result of the execution (in binary or other form).
The event Ev will then be sent to the various tasks Ti connected to the communication bus which will or will not be stimulated for another action, and so on until the end of the program (end stimulus event).

According to one embodiment, in the case where an executable has to be able to use input/output systems such as a display, a monitor or a keyboard, it is possible to process these input/output systems in two ways:
In the first case, the inputs-outputs (display) are not considered to form part of the sensitive areas, and therefore do not have a certain confidentiality level, so a particular task can directly implement unsecured scripts in order to report on the implementation of these inputs/outputs.
In a second case, the inputs/outputs, display, keyboard, etc., are considered to form part of the sensitive areas and therefore have a certain confidentiality level, so these inputs/outputs will be implemented via one of the cryptographic resources.

FIG. 10 diagrammatically represents an exemplary implementation of the invention on a multiprocessor system MP₁, MP₂, MP₃ or a cluster of computers managing encrypted or unencrypted python scripts Sk with a set of microprocessors interlinked via a communication bus BC allowing point-to-point communication in a network, better known as “unicast” communication, multicast communication or even communication from one point to a set of points (broadcast) such as the Ethernet standard. The cryptographic resource will in this context be implemented via a programmable component of Softcore FPGA (Field-Programmable Gate Array) type, that is to say, an FPGA component that has a microprocessor core. This component has the cryptographic functionalities for decrypting and storing associated encryption keys via the implementation of cryptographic algorithms and a computation unit for implementing a Python interpreter. In this context, the messages and the events will then be encapsulated in IP-type frames and the identifiers may correspond to the IP addresses associated with each of the entities (microprocessors and FPGA). FIG. 11 shows a second exemplary implementation of the invention on a single machine making it possible to execute a number of tasks in a partitioned manner. The tasks Ti comprise scripts coded in Python language or in JAVA language. These scripts, as already mentioned, may be encrypted. A number of operating systems OSi are ported to one and the same microprocessor, via a virtualization solution known to those skilled in the art of the software domain, and communicate via the interfaces of this IPC and CV paravirtualization software layer. In this context, the cryptographic resource is represented by a hardware component of ASIC type, directly linked to the virtualization layer and is accessible via the interfaces of this layer via a software messaging system (IPC Intern Process Communication or socket). The messages and the events will then be communicated via this internal messaging system to the paravirtualization layer. In this example, the cryptographic resource manages two types of interpreters (Java and Python) for the purpose of advantageous interoperability in the domains where the interpreted languages are used (database, administration, etc.). The cryptographic resource CE comprises elements similar to those described in FIG. 10.

In FIGS. 10 and 11, the external entity is a PC-type machine that has cryptographic capabilities equivalent to the resource CE in terms of cryptographic algorithm (for example, AES, 3DES, etc.) and keys or certificates.

The method and the system according to the invention notably have the advantage of being able to secure a portion or all of the executable software in case of attempted theft of an equipment item or illegal copying of a portion or of all of the code of an executable. This is particularly advantageous in the case of a confidential code in any type of equipment, whether during the execution of the code for an appliance that is operating or even when the equipment is stopped. The invention also makes it possible to combine several types of sensitive or nonsensitive, encrypted or unencrypted scripts. It has a capacity to disperse the execution of a portion or of all of the code in one or more resources CE in order to secure the execution of the program. It also offers the possibility of having an execution platform that can be made available to a subcontractor, with an original or proprietary code of a customer and not visible to the subcontractor. It therefore leads to the concept of protection in terms of confidentiality of the executable code in a context of client use or validation.

1. A method for securing a software package that can be broken down into a number of event-action type independent tasks, said tasks managing a set of encrypted or unencrypted scripts, said method comprising:
breaking down the software package to be secured into a number of independent tasks Ti,
upon the occurrence of a start event Evₛₜₐᵣₜ, selecting at least one of the tasks Ti consisting of a set of scripts,
said selected task or tasks Ti, the target of the event Evₛₜₐᵣₜ, will select one or more of their scripts according to their internal operating state corresponding to the progress of a task with respect to the program or software package, and will format at least one message with the appropriate scripts,
said task or tasks send said message or messages via a communication module encapsulating said message or messages according to the dedicated transmission medium,
transmitting said encapsulated message or messages to at least one dedicated resource via a communication means, said dedicated resource or resources being determined by a parameter included in said encapsulated message or messages,
said dedicated resource or resources then execute the encapsulated message or messages,
the execution of a script generates another event E'v including the identifiers necessary for the rest of the procedure, and the result of the execution, and
the event E'v will then be sent to the various tasks Ti connected to the communication means that will or will not be stimulated for another action, and so on until an end-of-process event Ev_{end} is received.

2. The method as claimed in claim 1, wherein at least one of the tasks comprises one or more encrypted scripts and wherein said dedicated resource is a cryptographic resource CE which decrypts the encapsulated message before executing it based on an identifying parameter contained in the script and associated with a decryption key.

3. The method as claimed in claim 1, wherein the communication means is a communication bus or a messaging system.

4. The method as claimed in claim 1, wherein the software package is an executable software package or in the form of interpretable code.

5. The method as claimed in claim 1, wherein the software package is a binary software package or in the form of interpretable code.

6. The method as claimed in claim 1, wherein said method uses a single resource CE and a virtualization software module adapted for partitioning different tasks Ti, each task being executed on an operating system OS which communicates with the virtualization module.

7. A system for securing or protecting a software package that can be broken down into a number of Event-25 Action type independent tasks, said tasks managing a set of scripts, said system comprising:
a module for encapsulating a selected module in a task Ti which is in turn selected according to the state of the software package and an external event, and for converting it into the form of a message encapsulating the selected module, and
a module for transmitting the message encapsulating the selected module via a communication means to one or more resources for executing said message and said selected module.

8. The system as claimed in claim 7, further comprising one or more cryptographic resources comprising a module for decrypting said selected encrypted module, associated with an encryption key and a module for executing said module after decryption.

9. The system as claimed in claim 7, wherein the communication system is a communication bus or a messaging system.

10. The system as claimed in claim 8, wherein the encryption module comprises at least one of the following encryption algorithms: a symmetrical Aes (Advanced Encryption Standard) algorithm, an asymmetrical RSA (Rivest Shamir Adleman) type algorithm, cryptographic algorithms and an encryption key Ks.

11. The system as claimed in claim 9, wherein the encryption module comprises at least one of the following encryption algorithms: a symmetrical Aes (Advanced Encryption Standard) algorithm, an asymmetrical RSA (Rivest Shamir Adleman) type algorithm, cryptographic algorithms and an encryption key Ks.
